(19) United States
(12) Patent Application Publication
(10) Pub. No.: US 2006/0276468 A1
(43) Pub. Date: Dec. 7, 2006

(54) Wood preservative formulations comprising Imazalil

(76) Inventor: Derek Philip Blow, Maidenhead (GB)

Correspondence Address: HODGSON RUSS LLP, ONE M & T PLAZA, SUITE 2000, BUFFALO, NY, 14203-2391, US

(21) Appl. No.: 11/433,038

(22) Filed: May 12, 2006

Related U.S. Application Data
(60) Provisional application No. 60/680,841, filed on May 12, 2005.

(51) Int. Cl. A01N 33/12; A01N 43/50

(52) U.S. Cl. 514/232.5; 514/396; 514/642

(57) ABSTRACT

The invention provides a wood preservative composition comprising a synergistic combination of imazalil or imazalil sulfate and one or more co-biocides. Examples of such co-biocides include triclosan, fenarimol, dichlorophen and chlorothalonil. The efficacy of potential wood preservative compositions can be tested by a simple test provided herein.

This application claims priority to U.S. Provisional application No. 60/680,841, filed on May 12, 2005, the disclosure of which is hereby incorporated by reference.

### FIELD OF THE INVENTION

The present invention relates generally to the field of preservation of cellulosic materials, and particularly to Imazalil-containing compositions for the preservation of cellulosic materials.

### BACKGROUND TO THE INVENTION

The treatment of non-durable timber with wood preservatives has been practiced for many years. Some of the more widely used wood preservatives are water based copper containing formulations, tar oil type preservatives and light organic solvent preservatives. Many of the preservative types that have been used successfully over many years are being restricted in their use in some parts of the world due to environmental concerns or health and safety considerations. Thus there exists a need for the development of wood preservative systems which address the environmental and safety issues.

Much of the treated non-durable timber used in contact with soil has historically been preserved with formulations containing copper and chromium, either alone or in combination with other ingredients such as arsenic. Copper chrome arsenic (CCA) has been widely used to treat timber that is used in many different service situations. Due to restrictions, other copper based systems are being increasingly used in many parts of the world. Many of the widely used replacements for CCA contain copper and one or more organic biocides. One example of a replacement for CCA is the so called Ammoniacal Copper Quaternary (ACQ) preservative. In some regions there is a desire to have replacements that either have a reduced metal content or are completely metal-free.

There are metal-free wood preservatives already available but such formulations have limitations. Boron compounds, such as boric acid, dissolve in water and leach out from treated timber under very wet conditions. Organic biocides, such as triazoles, may be used in organic solvent carriers but the solvents, which are usually of the white spirit type, are expensive and their evaporation into the atmosphere is not desirable. Other forms of wood preservation and wood protection exist but all have their limitations. Thus there is an ongoing need for the development of other systems.

In the development of new approaches and compositions for wood preservation, the time required to test a given composition is often considered to be lengthy. Ground contact field trials can vary considerably, but normally exposure sites are chosen such that decay of timber is quite rapid. Other reasons for choosing sites may include particular timber degrading organisms predominating in the area or the soil found in the region having particular characteristics. The trials often compare the performance of stakes treated with one or more experimental treatment with the performance of untreated stakes or stakes treated with one or more reference preservative. After the preparation of the replicate timber specimens, they are placed, partially buried in the ground at the exposure site. At intervals (often 6 months or one year intervals) each timber specimen is examined and inspections commonly continue until all specimens have failed. An example of a field test method is provided in EN 252. Such ground contact field trials may proceed for many years and for this reason more rapid laboratory tests have been developed.

One of the laboratory tests used to evaluate the performance of wood preservatives intended for possible ground contact use is ENV 807. In this test, timber mini-stakes (100×10×5 mm), are exposed in a soil substrate for periods of time up to 32 weeks. The mini-stakes have to be weighed at various times during the test which is time consuming. Additionally, after treatment the mini-stakes need to be dried and leached which with the other operations normally adds over 6 weeks to the period of testing. It is apparent that such a test as described in ENV 807 cannot be completed in less than about 9 months. While this is a great saving in time over that required for most field tests, such lab tests are still time consuming and therefore quicker, less labor-intensive approaches are desirable

### SUMMARY OF THE INVENTION

The present invention relates to a preservative composition for the treatment of wood and other cellulosic materials. The preservative composition comprises 1) Imazalil and/or Imazalil sulfate (this component hereafter referred to as “Imazalil”) and 2) a co-biocide, such that the combination of Imazalil and the co-biocide has a synergistic effect on the preservation of wood.

### BRIEF DESCRIPTION OF THE FIGURES

FIG. 1 is a plot of veneer half life versus imazalil sulfate in the presence of 0.019% propiconazole plus 0.019% tebuconazole plus 0.1805% OPP.

FIG. 2 is a plot of veneer half-life versus imazalil sulfate concentration.

FIG. 3 is a plot of veneer half life versus imazalil concentration.

### DESCRIPTION OF THE INVENTION

The use of imazalil or imazalil sulfate for protecting cellulosic materials such as wood and cotton is not new. However, in the present invention, it has been found that combining imazalil or imazalil salts, such as, for example, imazalil sulfate, with certain other wood protectants improves the wood preservative performance of imazalil to a surprising degree, not explained by simply adding the effectiveness of the individual components. The effect of combination is synergistic.

The composition of the present invention comprises imazalil or its salts, (for example, sulfate salt). The composition also comprises a synergistic co-biocide. Examples of synergistic co-biocides include quaternary ammonium compounds, such as, for example, DDAC, CarboQuat and BAC; azole-based biocides, such as, for example propiconazole and cyproconazole; morpholines, such as, for example, tridemorph and fenpropimorph. Also included are triclosan, fenarimol, poly(hexamethylenebiguanide)hydrochloride (referred to herein as PHMB), RH 287, chlorothalonil, copper naphthenate, pyraclostrobin, BBIT, salicylanilide, Triameen, guazatine acetates and dichlorophen.

Other names for imazalil, imazalil sulfate as well as their chemical biocide type are as follows:

Imazalil

Common name: Imazalil

IUPAC name: (RS)-1-(β-allyloxy-2,4-dichlorophenylethyl)imidazole; or

allyl(RS)-1-(2,4-dichlorophenyl)-2-imidazol-1-ylethyl ether
Chem abstract name: (±)-1-[2-(2,4-dichlorophenyl)-2-(2-propenyloxy)ethyl]-1H imidazole
Biocide type: azole

Imazalil Sulfate

Common name: Imazalil sulfate

Chemical name: imidazol-1-ylethyl ether; 1-(2-(2,4-dichlorophenyl)-2-(2-propenyloxy)ethyl)-1H-imidazole sulfatep; 1H-imidazole,1-(2-(2,4-dichlorophenyl)-2-(2-propenyloxy)ethyl)-, sulfate.

Biocide type: azole

The synergistic co-biocides which can be used in the composition of the present invention, as well as their chemical biocide type are as follows:

dichlorophen

Common name: dichlorophen

IUPAC name: 4.4′-dichloro-2,2′-methylenediphenol

Chem abstract name: 2,2′-methylenebis[4-chlorophenol]

Biocide type: Chlorophenol

Triclosan

Common name: triclosan

IUPAC name: 2,4,4′-tri-chloro-2′-hydroxy-diphenyl ether; alternative chemical name is 5-chloro-2-(2,4-dichlorophenoxy)phenol

Fenarimol

Common name: fenarimol

IUPAC name: (±)-2,4′-dichloro-α-(pyrimidin-5-yl)benzhydryl alcohol

Chem abstract name: (±)-α-(2-chlorophenyl)-α-(4-chlorophenyl)-=5-pyrimidinemethanol;

Biocide type: pyrimidinyl carbinol

PHMB

Common names: Poly(hexamethylenebiguanide)hydrochloride, polymeric biguanide hydrochloride

Chemical name: 1,6-hexanediamine, polymer with N,N′″-1,6-hexanediylbis{N′-cyanoguonidine}, hydrochloride

Trade name: Vantocil

CarboQuat

Trade Name: CarboQuat

Common name: DDACarbonate.

Chemical name: N,N-dialkyl-N,N-dimethylammonium bicarbonate/N,N-dialkyl-N,N-dimethylammonium carbonate

Biocide type: quaternary ammonium compound

DDAC

Common names: DDAC

Chemical names: didecyl dimethyl ammonium chloride or N,N-didecyl-N,N-dimethylammonium chloride.

Biocide type: quaternary ammonium compound

BAC

Common names: BAC

Chemical names: benzalkyl ammonium chloride or alkyl dimethyl benzyl ammonium chloride

Biocide type: quaternary ammonium compound

Tridemorph

Common name: tridemorph

IUPAC name: 4-alkyl-2,6-dimethylmorpholine

Biocide type: morpholine

Fenpropimorph

Common name: fenpropimorph

IUPAC name: (±)-cis-4-[3-(4-tert-butylphenyl)-2-methylpropyl]-2,6-dimethyl=morpholine

Chem abstract name: cis-4-[3-[4-(1,1-dimethylethylphenyl]-2-methylpropyl]-=2,6-dimethylmorpholine

Biocide type: morpholine

RH 287

Chemical name: 4,5-dichloro-2-n-octyl-3(2H)-isothiazolone

Trade name: Kathon RH 287

Biocide type: isothiazolone

Chlorothalonil

Common name: chlorothalonil

IUPAC name: tetrachloroisophthalonitrile

Chem abstract name: 2,4,5,6-tetrachloro-1,3-benzenedicarbonitrile

Guazatine Actates

Common name: guazatine acetates

IUPAC name: A mixture of reaction products from polyamines, comprising mainly octamthylenediamines, iminodi(octamethylene)diamine and octamethylenebis(imino-octamethylene)diamine, and carbamonitrile acetates.

Biocide type: guanidine

Pyraclostrobin

Common name: pyraclostrobin

IUPAC name: methyl N-{2-[1-(4-chlorophenyl)-1H-pyrazol-3-yloxymethyl]phenyl}(N-methoxy)carbamate

Chem abstract name: methyl[2-[[[1-(4chlorophenyl)-H-pyrazol-3yl]oxy]methyl]phenyl]methoxycarbamate

Biocide type: strobilurin

Copper Naphthenate

Chemical name: copper naphthenate

IUPAC name: copper naphthenate

Chemical abstracts name: copper naphthenates (CAS # 1338-02-9)

BBIT

Chemical name: 1,2-benzisothiazolin-3-one, 2-butyl- or N-butyl-1,2-benzisothiazolin-3-one CAS # 4299-07-4

Biocide type: isothiazolinone

Propiconazole

Common name: propiconazole

IUPAC name: (±)-1-[2-(2,4-dichlorophenyl)-4-propyl-1,3-dioxolan-2-ylmethyl-=1H-1,2,4-triazol

Chem abstract name: 1-[[2-(2,4-dichlorophenyl)-4-propyl-1,3-dioxolan-2-yl]=methyl]-1H-1,2,4-triazole

Biocide type: azole

Cyproconazole

Common name: cyproconazole

IUPAC name: (2RS,3RS;2RS,3SR)-2-(4-chloropheyl)-3-cyclopropyl-1--=(1H-1,2,4-triazol-1-yl)butan-2-ol

Chemical abstract name: α-(4-chlorophenyl)-α-(1-cyclopropylethyl)-=1H-1,2,4-triazol-1-ethanol

Biocide type: azole

Triameen

Trade name: TriameenY12D-30

Chem abstract name: N,N-bis(3-aminopropyl)dodeclamine

Other name: 1,3-propanediamine,N-(3-aminopropyl)-n-dodecyl-1,3-propanediamine,N-3-aminopropyl,N-dodecyl

Chemical type: alkyl amino propane

Salicylanilide

Common name: salicylanilide.

Chemical name: 2-hydroxy-N-phenylbenzamide and salicylic acid anilide.

Biocide type: benzanilide

The concentration of Imazalil and synergistic co-biocide (hereafter, for simplicity, both together referred to as “biocide”) in the solution used to treat wood (“treatment solution”) is dependent upon many factors, among them, the wood treatment method and the desired final concentration in the wood.

For example, if the treatment solution is applied using a superficial method of application, such as brushing or spraying, it may be necessary to use a higher biocide concentration in order to compensate for the lack of penetration which would result from high pressure application methods.

The type of wood or wood product may have an effect on the amount of wood preservative needed in the product to achieve a given efficacy. Some woods have lower natural decay resistance than others, and the attainment of a given decay resistance may require that such woods are treated with preservative fluids which contain a higher concentration of biocide than woods with higher natural decay resistance.

Furthermore, the intended use of the wood and anticipated types of exposure may be taken into account in determining the appropriate level of biocide in the wood. For example, uses in which the wood is to be exposed to tropical climates, marine environments, ground contact, etc. may accelerate the rate of decay relative to temperate, dry or sheltered, above ground exposures. For instance, timber decay generally proceeds more rapidly in tropical regions than in temperate regions. Furthermore, climatic conditions may influence the types of wood destroying organisms found in any particular region and the rate at which these organisms break down timber will tend to be faster in warmer conditions. To obtain a given degree of protection, higher levels of biocide may be required for timber exposed under tropical conditions than for timber exposed under more temperate conditions.

In general, the final concentration of wood preservative in the wood can be adjusted based on the intended use and exposure of the wood. In many applications, an Imazalil concentration of from 0.0001 to 0.2500 grams of biocide per gram of wood or wood product, when expressed in terms of the oven dry weight of timber or other cellulosic material, is sufficient. In the case of treatments which do not penetrate to the center of the wood, only the wood which actually contains the biocide, i.e., the penetrated zone, is used in the foregoing ratio. By “penetrated zone,” it is meant the three dimensional volume within the wood wherein the concentration of Imazalil is greater than about 0.00001 grams of biocide per gram of wood or wood product. If a salt of Imazalil is used, only the weight of the Imazalil is used to calculate this ratio, and the weight of the anion (such as, for example, sulfate) is excluded.

The compositions of the present invention can be prepared and stored as concentrates which are diluted before use. Such concentrates can reduce the cost of transport and storage. The concentrate can have the same proportions of Imazalil to co-biocide as the ready-to-use composition, i.e., the wood preservative in the form that it is applied to timber or other wood products. However, if convenient, the relative concentrations of the Imazalil and co-biocide can be adjusted during or after dilution before application of the composition to wood.

In the ready-to-use wood preservative, i.e., the wood preservative in the form it is to be applied to timber, Imazalil and the synergistic co-biocide are each present at concentrations of from about 0.01 weight % to 50 weight % of the solution. In a preferred embodiment, Imazalil and the synergistic co-biocide are each present at concentrations in the range of from about 0.01 to 5.0 wt % of the solution, and in a more preferred embodiment, in the range of from about 0.1 to 2.0 wt %. Generally, the more preservative that is retained in a wood or wood product, or other cellulosic material the longer it will be protected when placed in a situation where biological decay could occur.

The ready-to-use solution (as well as the concentrate if no adjustment of biocide concentrations has been necessary), contains Imazalil and the co-biocide in amounts such that the weight ratio of the Imazalil to co-biocide is in the range of from about 0.1 gram of Imazalil per gram of co-biocide to 100 grams of Imazalil per gram of co-biocide. However, it is preferable to have a ratio in the range of from about 0.5 to 50 gram of Imazalil per gram of co-biocide. Even more preferred is a ratio in the range of from about 0.5 to 1.5 grams of Imazalil per gram of co-biocide. As above, only the weight of imazalil is used in the calculation of the ratio. The weight of counter ions, such as are generally present when a salt of imazalil is used, are disregarded.

In another preferred embodiment, Imazalil and the co-biocide are present in the ready-to-use composition such that 1) the weight ratio of Imazalil to co-biocide is in the range of from about 0.5 to 1.5 grams of Imazalil per gram of co-biocide and 2) Imazalil and the co-biocide are each present at concentrations in the range of from about 0.01 to 5.0 wt % of the composition, and more preferably, about 0.1 to 1.5 wt % of the composition.

The composition of the present invention is effective in preventing decay in a wide variety of woods and wood products. Solid timber of various hardwood and softwood trees can be used. Furthermore, board materials, such as plywood, blockboard, laminates, flakeboard, chipboard and fibreboard, veneers, slices or particles of timber or other cellulosic material held together to form a board or beam as well as other materials produced from timber or other cellulosic material can be preserved with the composition of the present invention.

In addition to Imazalil and one or more other wood preservative synergistic co-biocide agents provided above, the composition may also contain other additives which may have biocidal properties.

Additional biocides such as, for example, fungicides and insecticides, may be present as well. Non-limiting examples of fungicides which can be used are azoles, such as, for example tebuconazole, and prochloraz; metal containing fungicides, such as, for example, copper soaps, zinc soaps, amine copper, copper 8 quinolinolate, tributyl tin compounds; isothiazolones; IPBC; and boron compounds, such as for example, disodium octaborate and boric acid.

Non-limiting examples of insecticides which can be used are synthetic pyrethroids, such as, for example, permethrin, cypermethrin, and bifenthrin; organophosphates such as, for example, phoxim and chlorpyrifos; chloronicotinyls, such as, for example, imidacloprid; and phenylpyrazoles, such as, for example, fipronil. Other examples of commonly available insecticides which can be used are, chlorfenapyr, clothianidin, etofenprox, and neonicotinoid insecticides such as thiamethoxam and thiacloprid.

The composition of the present invention can be prepared in polar or non-polar solvents, or a mixture of both. The choice of solvent employed generally is dependent upon the solubility properties of imazalil, the co-biocide and whether a solution or an emulsion or dispersion is desired. Suitable solvents include water, hydrocarbon solvents of both the aliphatic and aromatic types (such as, for example, white sprit, odorless kerosene, diesel oil, xylene and toluene), oxygenated solvents (such as, for example, alcohols, ketones, esters and glycol ethers), and vegetable oils both processed and natural (such as linseed oil, castor oil and rape seed oil). Blends of oil types may also be used to produce the desired properties. The identification of suitable solvents is within the purview of those skilled in the art. In one embodiment, the solvent is a volatile solvent such as water or white spirit.

In general, the solvent is lost through evaporation after the wood has been treated, and thus the choice of solvent is not expected to have a great effect on the presence or degree of synergy exhibited by the treated wood. However, diesel oil and other non-volatile solvents, such as those known in the art, can be used. Water is a preferred solvent in that it evaporates completely. Furthermore, water is convenient because Imazalil has very little solubility in water, but Imazalil salts have high solubility in water, and thus compositions can be prepared in which the Imazalil component (“Imazalil component” here includes Imazalil compounds, such as Imazalil or its salts) is micronized, soluble or partially soluble, depending on the proportions of the soluble and insoluble Imazalil compound used. However, other solvents can be used. In one embodiment, the solvent is a volatile solvent such as water or white spirit.

The compositions of the present invention may further comprise additives such as one or more compounds of the following types: water repellents, pigments, dyes, anti-foaming additives, wetting agents or penetration aids. Examples of water repellents which can be used include waxes, wax emulsions and silicones. Pigments which can be used include iron oxide-type pigments, and dyes, examples of which include azo dyes, acid dyes and basic dyes. Anti-foaming agents include siloxanes and other oil soluble surfactants. Wetting agents include a wide range of surfactants. Penetration aides, examples of which include chelating agents, imines and surfactants, can be used, if desired.

Additives such as resins, non-drying co-solvents, water repellents, non-biocidal components (such as water repellants, colorants, emulsifying agents, dispersants, stabilizers, UV inhibitors, and the like) may also be included in the compositions disclosed herein to further enhance their performance, or the appearance and performance of the resulting treated products.

If desired, the Imazalil, the synergistic co-biocide component or both can be present in the composition of the present invention as a suspension, emulsion, dispersion, etc. of particles droplets. In one embodiment, the average particle size of such a suspension is in the range of from 0.005 to 25 microns. Compositions of the present invention in the concentrate and ready for use forms may be used as a liquid, paste, suspension or solution.

The compositions of the present invention can be prepared by standard methods. One such method is to dissolve the biocide components in the desired solvent. In another method, Imazalil and/or the synergistic co-biocide components are obtained in particulate form, and a suspension, dispersion or emulsion is formed. In general, both the Imazalil and the synergistic co-biocides can be added to the solvent simultaneously or in either order. If desired, separate solutions containing each component, each either fully dissolved or in particulate form, can be prepared and combined.

The biocide mixtures of the present invention can be applied to wood and cellulosic products by a variety of methods including pressure and non pressure methods. Pressure methods include double vacuum impregnation, vacuum pressure (Full Cell and Empty Cell types), pressure injection, vacuum pressure injection, and vacuum pressure impregnation. Non-pressure methods include brushing, coating, spraying, immersion, dipping, steeping, diffusion, and hot and cold open tank methods. In one embodiment, the double vacuum and vacuum pressure methods are used.

With many treatment processes it is preferable that the timber be seasoned or dry before application of the biocidal solution. However, if a diffusion method of application is used, it is preferable that the wood contain a considerable amount of water to allow the Imazalil synergistic co-biocide combination to diffuse into the wood cells.

It has generally been found that when micronized particles are used (i.e., particles having a largest diameter in the range of from 0.001 to 25.0 microns), particle size has an effect on penetration of the dispersion formulation into the cellular structure of the wood or other cellulose-based material. Particles with sizes in excess of 10 microns may be filtered by the surface of the wood and thus may not be uniformly distributed within the cell and cell wall. The primary entry and movement of fluids through wood tissue occurs primarily through the tracheids and border pits. Tracheids have a diameter of about thirty microns. Fluids are transferred between wood cells by means of border pits and cross field pits.

The overall diameter of the border pit chambers typically varies from a several microns up to thirty microns while, the diameter of the pit openings (via the microfibrils) typically varies from several hundredths of a micron to several microns.

Particles having sizes smaller than the pit openings generally have an increased ability to penetrate the wood matrix. Thus, increasing weight percent of particles having diameters less that the pit openings generally correlates with increasing degree of penetration and increasing uniformity of particle distribution within the wood.

The micronized biocides used in the dispersion formulation disclosed herein typically do not have appreciable amounts of particles with sizes exceeding 30 microns or the biocide may not effectively penetrate the wood tissue. In one embodiment, the particle size of substantially all of the micronized particles used in the dispersion formulation disclosed herein is between 0.001-10 microns. In another embodiment, the particle size of substantially all of the micronized particles is between 0.005 to 1.0 micron. In another embodiment, the particle size of substantially all of the micronized particles is between 0.05 to 10.0 microns. If a more uniform penetration is desired, particle size of substantially all of the micronized particles in the dispersion formulation disclosed herein can be between 0.05-1.0 microns. “Substantially all,” as used above, means greater than 80 wt %. In other embodiments, greater than 85, 90, 95 or 99 wt % of the total particulate in the formulation satisfies the embodiments listed in this paragraph.

Particles which are too large can clog the wood, preventing it from taking in other particles. Thus particle size distributional parameters can affect the uniformity of particle distribution in the wood, as well as the leaching properties of treated wood. It is thus preferable, but not essential, to use particle size distributions which contain relatively few particles with sizes outside the range of 0.001 to 25 microns. It is preferred that no more than 20 weight percent of the particles have diameters which are greater than 25 microns. Because smaller particles have an increased chance of leaching from the wood, it is also preferred that no more than 20 wt % of the particles have diameters under 0.001 microns. Regardless of the foregoing recommendations, it is generally preferred that greater than 60 wt % of the particles have a diameter in the range of 0.001 to 25 microns. In more preferred embodiments, greater than 80, 85, 90, 95 or 99 wt percent of the particles are in the range of 0.001 to 25 microns.

For increased degree of penetration and uniformity of distribution, at least 50 wt % of the particles should have diameters which are less than 10 microns. More preferred are particle distributions in which at least 65 wt % of the particles have sizes of less than 10 microns. In additional embodiments, less than 20 wt % of the particles have diameters of less than 1 micron.

The present invention also provides a method for preservation of wood. In one embodiment, the method comprises the steps of treating wood with composition (treating fluid) comprising a dispersion of micronized Imazalil, co-biocide, or both. Preferably, greater than 60 wt % of the micronized particles are between 0.001 and 25 microns, and in other embodiments, between 0.005 and 10 microns, between 0.05 and 10 microns and between 0.05 and 1.0 microns.

The present invention is not limited to applications which involve micronized particles which have been applied to wood as such. For example, the wood preservative effect of micronized particles can be realized by the formation of such particles in situ. By in situ, it is meant that particle formation takes place on or within the wood. Thus, the benefits of the present invention can be realized if particle formation takes place, for example, within the tracheids of the wood to be preserved. Additionally or instead, particle formation can take place outside of the tracheids, with the subsequent movement of at least some of the particles into the tracheids. Such a movement can be caused by, for example, pressure cycling, such as described in the examples. The micronized particles generally have an average size which is small enough such that the particles in the composition at least partially penetrate wood by particle migration through tracheids and border pits.

The composition containing micronized particles may be applied to wood by impregnation, dipping, soaking, spraying, brushing, or other means well known in the art. In a preferred embodiment, if the Imazalil or co-biocide are present as micronized particles, and vacuum and/or pressure techniques are used to impregnate the wood in accord with this invention, including standard processes such as the “Empty Cell” process, the “Modified Full Cell” process and the “Full Cell” process, and other vacuum and/or pressure processes which are known to those skilled in the art. It has been observed with micronized particles that in most cases, at least 10 wt % of the particles present in the wood or wood product substrate after treatment have penetrated to a depth of 0.3 mm or greater. In other embodiments, at least 20 or 35 wt % of the micronized particles present in the wood substrate after treatment have penetrated to a depth of 0.3 mm or greater.

The standard processes are defined as described in AWPA Standard C1-03 “All Timber Products—Preservative Treatment by Pressure Processes”. In the “Empty Cell” process, prior to the introduction of preservative, materials are subjected to atmospheric air pressure (Lowry) or to higher air pressures (Rueping) of the necessary intensity and duration. In the “Modified Full Cell”, prior to introduction of preservative, materials are subjected to a vacuum, preferably of less than 77 kPa (22 inch Hg) (sea level equivalent). A final vacuum which is preferably not less than 77 kPa (22 inch Hg) (sea level equivalent) is used. In the “Full Cell Process,” prior to introduction of preservative or during any period of condition prior to treatment, materials are subjected to a vacuum of preferably not less than 77 kPa (22 inch Hg). A final vacuum of preferably not less than 77 kPa (22 inch Hg) is used.

Wooden posts and poles in damp or wet soil are examples of timber commodities exposed under very severe conditions. With part of the timber below the surface of the soil and part of the timber above ground level there exists a range of micro-environments. Below ground level there will be excess moisture but relatively little oxygen while at the top of the post or pole the tendency will be for the reverse to be true. Normally decay of timber proceeds most rapidly near to the junction of the portion above and below ground level (ground line) where there will be a balance between oxygen and moisture. Field trials have been undertaken in many parts of the world where timber stakes, posts or poles are exposed part buried in the ground.

The present invention also provides a simple exposure test for evaluating the wood preserving abilities of candidate ingredients or compositions. This exposure test is based on the premise that small dimension timber test specimens tend to fail more quickly than larger ones in soil contact situations.

It is preferable that the thickness of the veneers be greater than 0.1 mm, as veneers of lesser thickness can often be pulled apart by hand without undergoing exposure to decay organisms. Veneers which are thicker than 0.4 may take an excessive amount of time to fail the exposure test. In one embodiment, the thickness of the veneers is about 0.2 mm and the wood is the sapwood of the Scots pine (Pinus sylvestris). Other woods and thicknesses can be used. However, it is preferable that the veneers do not easily pull apart by hand before they are weakened by decay, or take an excessive amount of time, particularly in the absence of biocide, to fail the exposure test. For example, 0.2 mm thick Scots pine sapwood veneers which are exposed as outlined below generally fail in under 5 weeks. An example of convenient width and length dimensions are 15×50 mm. However, width and length are not critical provided they are kept consistent within a test, although very large or small length or width dimensions may be difficult to handle.

Accordingly, the test of the present invention comprises testing the integrity of a veneer after exposure to a decay-inducing environment. In one embodiment, this environment is damp compost in which decay organisms are present and water is present at just above the water holding capacity of the compost. If desired, other media can be used, and the test can be conducted at water contents which are below, at, or above the water-holding capacity of the media.

In general, the integrity of the veneer is inversely related to the length of exposure to the decay promoting environment. The integrity of the veneer can be tested by applying a force to the veneer and noting whether or not the veneer breaks. Thus, if wood preservative agents are applied to the veneers, these veneers would be expected to withstand longer exposure to the environment without breaking compared to control veneers without breaking.

The force applied to the veneers is preferably a force which pulls the two ends in opposite directions. The force can be applied by the use of an instrument or manually. If there is significant decay the veneer will break, generally near the junction between the portion submerged in the decay accelerating medium and the portion exposed to air. If the force is applied manually, it is preferable that the same individual conduct the test at the various exposure time points.

The following examples are provided to further describe the invention and are not intended to be restrictive in any way. In the examples below, the complexities of the testing methods give rise to slight variations in testing conditions between examples.

### EXAMPLE 1

This example demonstrates the synergy obtained when imazalil sulfate and synergistic co-biocides are used together. Veneers of Scots pine Pinus sylvestris (0.2 mm thick, 50×15 mm) sapwood are cut from test blocks as described in EN 113, a known standard test method in the European timber industry. The veneers were cut such that both late wood and early wood were present in each veneer. The following biocides were tested: imazalil sulfate, dichlorophen, fenarimol, triclosan, and PHMB. To allow the mixing together of the five selected biocides in any combination the biocides were formulated such that they could be mixed together (all the percentages are mass/mass):

Imazalil Sulfate

0.40% Imazalil sulfate

Dichlorophen

0.67% Dichlorophen (90% active)

(The above contains about 0.60% m/m active dichlorophen)

Triclosan

0.20% Triclosan

Fenarimol

0.80% Fenarimol

PHMB

0.80% PHMB

Test solutions were prepared and sets of veneers were dip treated such that there were 6 replicate veneers for each treatment under investigation. Additionally six veneers were dip treated in deionised water to act as water controls. Being thin, the timber veneers dried quickly. Plastic containers (approximately 350×220 mm by at least 60 mm high) were part filled with John Innes Number 2 potting compost at a little above its water holding capacity. The veneers for this particular test were placed in six rows within a container such that approximately half the veneer was below the compost and half above. The veneers were placed in the compost such than those given a particular treatment were distributed throughout the container and were not grouped together. The containers, compost and veneers were weighed then incubated at about 30° C. and near 100% relative humidity in an incubator. Each week during the test the assembly was reweighed and deionised water added to bring it back to its original mass. After 3 weeks each veneer was examined in turn. It was held between the fore finger and thumb at each end and pulled to see if it could be broken. If it could be pulled apart a failure was recorded. If the veneer was sound, this was recorded and the veneer was returned to its original position. After a further one week incubation all sound veneers were assessed again as described above, with the same person conducting the assessments. The assessments continued until all veneers in the container failed. From the results, the average life in weeks were calculated for the water control veneers or veneers treated with a particular composition. The results are presented below.

In the first test each of the above five formulations were tested and also mixtures such that 50% of the imazalil sulfate test fluid was added to 50% of the other test fluids. The combinations tested are illustrated in the table below:

TABLE 1

| | Dichloro- | | | | Imazalil |
|---|---|---|---|---|---|
| | phen | Trichlosan | Fenarimol | PHMB | sulfate |
| Dichloro- | 0.6% | | | | |
| phen | | | | | |
| Trichlosan | | 0.2% | | | |
| Fenarimol | | | 0.8% | | |
| PHMB | | | | 0.8% | |
| Imazalil | 0.3% | 0.1% | 0.4% | 0.4% PHMB | 0.4% |
| sulfate | Dichloro- | Trichlosan | Fenarimol | and 0.2% | Imazalil |
| | phen | and 0.2% | and 0.2% | Imazalil | sulfate |
| | and 0.2% | Imazalil | Imazalil | sulfate | |
| | Imazalil | sulfate | sulfate | | |
| | sulfate | | | | |

The above 9 formulations were used to treat sets of veneers as described above. Deionised water was also used to prepare water controls. The average half lives for each treatment were calculated. To illustrate the way in which half lives were calculated the following example is provided:

In the case of the six replicate veneers treated with 0.2% Triclosan no veneers failed at the 3 week inspection, four veneers failed at the 4 week inspection and the remaining two veneers failed at the five week inspection. The following six values represent the time (in weeks) when failures occurred 4, 4, 4, 4, 5 and 5. These values were added together (26) and divided by six to give an average of ca 4.33. This value of 4.33 is the average time, in weeks, for failure to occur. The equivalent average times for failure to occur for the other treatments examined in test 1 are presented in Table 2. The comparative value for water control was 3.8.

TABLE 2

| | Dichloro- | | | | Imazalil |
|---|---|---|---|---|---|
| | phen | Trichlosan | Fenarimol | PHMB | sulfate |
| Dichloro- | 9.50 | | | | |
| phen | | | | | |
| Trichlosan | | 4.33 | | | |
| Fenarimol | | | 7.17 | | |
| PHMB | | | | 4.83 | |
| Imazalil | 11.17 | 5.50 | 6.67 | 5.17 | 5.17 |
| sulfate | (7.34) | (4.75) | (6.17) | (5.00) | |

values in parentheses are estimated expected values
Bold figures indicate where the calculated half life exceeds the estimated half life.

From the above table it can be seen that the average time for failure to occur for veneers treated with 0.6% dichlorophen is 9.50 weeks and for veneers treated with 0.4% imazalil sulfate is 5.17 weeks. If 0.3% dichlorophen and 0.2% imazalil sulfate are combined (half the amount of each biocide) it is expected that, if the effect is additive, the resultant average time for failure to occur should be midway between 9.50 and 5.17 weeks, namely about 7.34 weeks. However, when the combination of 0.3% dichlorophen plus 0.2% imazalil sulfate was actually tested the average time for failure to occur was found to be 111.17 weeks. Any such increase in performance is termed here as positive synergy in the context of this patent. In the above table, expected average times for failure to occur for each combination of biocides are shown in parentheses. These expected average times for failure to occur have been calculated as described above. These calculated values have been rounded up to the first place of decimals, where necessary.

It is surprising that in all instances where imazalil sulfate is one of the biocides in the combination the actual average time to failure found by testing is greater than the estimated one shown in the table above. The effect is most marked when imazalil sulfate is combined with dichlorophen but is also evident when imazalil sulfate is combined with triclosan or fenarimol or PHMB. These results demonstrate positive synergy according to the definition provided earlier.

### EXAMPLE 2

This example describes the synergistic wood preservative action of imazalil sulfate and a quaternary ammonium compound, contrasted with the non-synergistic results obtained with another quaternary ammonium compound. The following two quaternary ammonium compounds were tested:

1. Didecyldimethylammonium chloride commonly referred to as DDAC.

2. N,N-didecyl-N-methyl-poly(oxethyl)ammonium propionate which is sold under the trade name Bardap 26.

The above two quaternary ammonium compounds were used to prepare test composition fluids as follows (all the above percentages are mass/mass and each of the three test fluids above contain approximately 0.36% active quaternary ammonium compound).

DDAC

0.72% Bardac 22 (50% DDAC)

99.28% Deionised water

Bardap

0.51% Bardap 26 (70% active)

99.49% Deionised water

The combinations tested are summarised in the table below:

TABLE 3

| | Imazalil sulfate | Quat Only |
|---|---|---|
| DDAC | 0.18% active DDAC | 0.36% active DDAC |
| | 0.30% Imazalil sulfate | |
| Bardap 26 | 0.18% active Bardap 26 | 0.36% active Bardap 26 |
| | 0.30% Imazalil sulfate | |
| No Quat | 0.60% Imazalil sulfate | |

The above 5 formulations were used to treat sets of veneers as described in Example 1. Deionised water was also used to prepare water controls. A veneer test was conducted as previously described and average times for failure to occur for the treatments examined are presented in Table 4. The value for water control was 3.67 weeks.

TABLE 4

| | Imazalil sulfate | Quat Only |
|---|---|---|
| DDAC | 5.50 (4.92) | 4.17 |
| Bardap 26 | 5.33 (5.34) | 5.00 |
| No Quat | 5.67 | — |

values in parentheses are estimated expected values
Bold figures indicate where the calculated half life exceeds the estimated half life, suggests synergy.

From the above table it can be seen that the average time for failure to occur for veneers treated with 0.36% active DDAC is 4.17 weeks and for veneers treated with 0.4% imazalil sulfate it is 5.67 weeks. If 0.18% active DDAC and 0.2% imazalil sulfate are combined (half the amount of each biocide) it is expected that, if the effect is additive, the resultant average time for failure to occur should be midway between 4.17 and 5.67 weeks, namely about 4.92 weeks. However, when the combination of 0.18% active DDAC plus 0.2% imazalil sulfate was actually tested, the average time for failure to occur was found to be 5.50 weeks. Any such increase in performance is termed here as positive synergy. Below the expected average times for failure to occur for each combination of biocides are shown in parenthesis. These expected average times for failure to occur have been calculated as described above. These calculated values have been rounded up to the first place of decimals.

Only where imazalil sulfate was combined with DDAC was there evidence of synergy in this test. Bardap gave an average time for failure which approximates that predicted in the case of no synergy.

### EXAMPLE 3

This example demonstrates the synergistic effect of imazalil sulfate with wood protectants DDAC, CarboQuat, BAC, dichlorophen, pyraclostrobin tridemorph, fenpropimorph. The Exposure test was performed and half-lives were calculated as in Example 1. The biocides were formulated as set forth in Table 5 (all the percentages are mass/mass):

TABLE 5
Solutions in IMS = Industrial methylated spirits (Alcohol)

| Fungicide | No Addition | With Dichlorophen |
|---|---|---|
| DDAC | 2% DDAC | 1% DDAC |
| | | 1% Imazalil sulfate |
| CarboQuat | 2% CarboQuat | 1% CarboQuat |
| | | 1% Imazalil sulfate |
| BAC | 2% BAC | 1% BAC |
| | | 1% Imazalil sulfate |
| Dichlorophen | 2% Dichlorophen | 1% Dichlorophen |
| | | 1% Imazalil sulfate |
| Pyraclostrobin | 2% Pyraclostrobin | 1% Pyraclostrobin |
| | | 1% Imazalil sulfate |
| Tridemorph | 2% Tridemorph | 1% Tridemorph |
| | | 1% Imazalil sulfate |
| Fenpropimorph | 2% Fenpropimorph. | 1% Fenpropimorph |
| | | 1% Imazalil sulfate |
| Imazalil sulfate | 2% Imazalil sulfate | Not applicable |

Calculated half lives derived from the soil contact veneer tests are summarised in Table 6:

TABLE 6
Solutions in IMS (Alcohol)

| | Half life for | |
|---|---|---|
| | fungicide at 2% | Half life for 1% fungicide |
| Fungicide | active ingredient (ai) | plus 1% Imazalil sulfate |
| DDAC | 5.00 weeks | 6.50 weeks {5.50 weeks} |
| CarboQuat | 5.33 weeks | 5.83 weeks {5.67 weeks} |
| BAC | 5.17 weeks | 6.17 weeks {5.59 weeks} |
| Dichlorophen | 19.83 weeks | 15.33 weeks {12.92 weeks} |
| Pyraclostrobin | 6.17 weeks | 6.50 weeks {6.09 weeks} |
| Tridemorph | 4.83 weeks | 6.33 weeks (5.42 weeks) |
| Fenpropimorph | 4.67 weeks | 5.67 weeks (5.34 weeks) |
| Imazalil | 6.00 weeks | Not applicable |
| sulfate | | |

values in parentheses are estimated expected values
Bold figures indicate where the calculated half life exceeds the estimated half life, suggests synergy.

### EXAMPLE 4

This example demonstrates the lack of synergy when imazalil sulfate is combined with a co-biocide which is not one of the synergistic partners identified above. The combination of imazalil sulfate and guazatine acetates (commercially available as Panoctine.

The specific acetates as defined by CAS # 115044-19-4 are examined. The Exposure test was performed and half-lives were calculated as in Example 1. The biocides were formulated as set forth in Table 7 (all the percentages are mass/mass):

TABLE 7
Solutions in deionised water

| Fungicide | No addition | With Imazalil sulfate |
|---|---|---|
| Guazatine acetates | 2% Guazatine acetates | 1% Guazatine acetates |
| | | 1% Imazalil sulfate |
| Imazalil sulfate | 2% Imazalil sulfate | Not applicable |

Calculated half lives derived from the soil contact veneer tests are summarised in Table 8:

TABLE 8
Solutions in acetone

| | | Half life for 1% |
|---|---|---|
| | Half life for | fungicide plus 1% |
| Fungicide | fungicide at 2% ai | Imazalil sulfate |
| Guazatine acetates | 4.67 weeks | 5.83 weeks |
| | | {5.92 weeks} |
| Imazalil sulfate | 7.17 weeks | Not applicable |

value in parenthesis is estimated expected values.

### EXAMPLE 5

This example demonstrates the synergistic effect of imazalil with wood protectants RH 287, chlorothalonil, and propiconazole. The Exposure test was performed and half-lives were calculated as in Example 1. The biocides were formulated as set forth in Table 9 (all the percentages are mass/mass). The combinations under test (with percentages) are summarized in Table 9 below:

TABLE 9
Solutions in acetone

| Fungicide | No Addition | With Imazalil |
|---|---|---|
| RH 287 | 2% RH 287 | 1% RH 287 |
| | | 1% Imazalil |
| Chlorothalonil | 2% Chlorothalonil | 1% Chlorothalonil |
| | | 1% Imazalil |
| Propiconazole | 2% Propiconazole | 1% Propiconazole |
| | | 1% Imazalil |
| Imazalil | 2% Imazalil | Not applicable |

Calculated half lives derived from the soil contact veneer tests are summarised below in Table 10:

TABLE 10
Solutions in acetone

| | | Half life for 1% |
|---|---|---|
| | Half life for | fungicide plus |
| Fungicide | fungicide at 2% ai | 1% Imazalil |
| RH 287 | 22.50 weeks | 19.33 weeks |
| | | {15.09 weeks} |
| Chlorothalonil | 12.17 weeks | 10.67 weeks |
| | | {9.92 weeks} |
| Propiconazole | 5.50 weeks | 7.33 weeks |
| | | {6.59 weeks} |
| Imazalil | 7.67 weeks | Not applicable |

values in parentheses are estimated expected values
Bold figures indicate where the calculated half life exceeds the estimated half life, suggests synergy.

### EXAMPLE 6

This example demonstrates the synergistic effect of imazalil with wood protectant copper in the form of copper naphthenate. The Exposure test was performed and half-lives were calculated as in Example 1. The biocides were formulated as set forth in Table 11 (all the percentages are mass/mass). The combinations under test (with percentages) are summarized in Table 11 below:

TABLE 11
Solutions in xylene

| Fungicide | No Addition | With Imazalil |
|---|---|---|
| Copper (as copper | 2% Copper | 1% Copper |
| naphthenate) | | 1% Imazalil |
| Imazalil | 2% Imazalil | Not applicable |

Calculated half lives derived from the soil contact veneer tests are summarised below in Table 12:

TABLE 12
Solutions in xylene

| | | Half life for 1% |
|---|---|---|
| | Half life for | fungicide plus |
| Fungicide | fungicide at 2% ai | 1% Imazalil |
| Copper (as copper | 14.83 weeks | 11.67 weeks |
| naphthenate) | | {10.50 weeks} |
| Imazalil | 6.17 weeks | Not applicable |

values in parentheses are estimated expected values
Bold figures indicate where the calculated half life exceeds the estimated half life, suggests synergy.

### EXAMPLE 7

This example demonstrates the synergistic effect of imazalil with the wood protectant cyproconazole. The Exposure test was performed and half-lives were calculated as in Example 1. The biocides were formulated as set forth in Table 13 (all the percentages are mass/mass). The combinations under test (with percentages) are summarized in Table 13 below:

TABLE 13
Solutions in Acetone

| | | | Low level with |
|---|---|---|---|
| Fungicide | High level | Low level | 0.8% Imazalil |
| Cyproconazole | 1.6% | 0.8% | 0.8% Cyproconazole |
| | Cyproconazole | Cyproconazole | 0.8% Imazalil |
| Imazalil | 1.6% Imazalil | 0.8% Imazalil | Not applicable |

Calculated half lives derived from the soil contact veneer tests are summarised below in Table 14:

TABLE 14
Solutions in Acetone

| | High level | Low level | Low level (0.8%) |
|---|---|---|---|
| Fungicide | (1.6%) | (0.8%) | plus 0.8% Imazalil |
| Cyproconazole | 4.67 weeks | 4.17 weeks | 6.17 weeks |
| | | | {5.42 weeks} |
| Imazalil | 6.17 weeks | 5.50 weeks | Not applicable |

values in parentheses are estimated expected values
Bold figures indicate where the calculated half life exceeds the estimated half life, suggests synergy.

### EXAMPLE 8

This example demonstrates the synergistic effect of imazalil with the wood protectant Triameen Y12D-30. The Exposure test was performed and half-lives were calculated as in Example 1. The biocides were formulated as set forth in Table 15 (all the percentages are mass/mass). The combinations under test (with percentages) are summarized in Table 15 below:

TABLE 15
Solutions in IMS (Alcohol)

| | | | Low level with |
|---|---|---|---|
| Fungicide | High level | Low level | 0.8% Imazalil |
| Triameen | 1.6% active | 0.8% active | 0.8% active |
| Y12D-30 | Triameen | Triameen | Triameen |
| | | | 0.8% Imazalil |
| Imazalil | 1.6% Imazalil | 0.8% Imazalil | Not applicable |

Calculated half lives derived from the soil contact veneer tests are summarized below in Table 16:

TABLE 16
Solutions in IMS (Alcohol)

| | High level | Low level | Low level (0.8%) |
|---|---|---|---|
| Fungicide | (1.6%) | (0.8%) | plus 0.8% Imazalil |
| Triameen | 5.00 weeks | 4.33 weeks | 6.00 weeks |
| Y 12D-30 | | | {5.75 weeks} |
| Imazalil | 6.50 weeks | 5.33 weeks | Not applicable |

values in parentheses are estimated expected values
Bold figures indicate where the calculated half life exceeds the estimated half life, suggests synergy.

### EXAMPLE 9

This example demonstrates the synergistic effect of imazalil sulfate with the wood protectant BBIT. The Exposure test was performed and half-lives were calculated as in Example 1. The biocides were formulated as set forth in Table 17 (all percentages are mass/mass). The combinations under test (with percentages) are summarized in Table 17 below:

TABLE 17
Formulations which can be mixed together

| Fungicide | No addition | With Imazalil sulfate |
|---|---|---|
| BBIT | 1.4% BBIT | 0.7% BBIT |
| | | 0.2% Imazalil sulfate |
| Imazalil sulfate | 0.4% Imazalil sulfate | Not applicable |

Calculated half lives derived from the soil contact veneer tests are summarized below in Table 18:

TABLE 18
Formulations which can be mixed together

| Fungicide | No addition | With Imazalil sulfate |
|---|---|---|
| BBIT | 8.33 weeks | 7.33 weeks |
| | | {6.92 weeks} |
| Imazalil sulfate | 5.50 weeks | Not applicable |

values in parentheses are estimated expected values
Bold figures indicate where the calculated half life exceeds the estimated half life, suggests synergy.

### EXAMPLE 10

This example demonstrates the synergistic effect of imazalil with the wood protectants fenpropimorph, propiconazole and cyproconazole. The Exposure test was performed and half-lives were calculated as in Example 1. The biocides were formulated as set forth in Table 19 (all the percentages are mass/mass). The combinations under test (with percentages) are summarized in Table 19 below:

TABLE 19
Solutions in IMS (Alcohol)

| | | | Low level with |
|---|---|---|---|
| Fungicide | High level | Low level | 0.8% Imazalil |
| Fenpropimorph | 1.6% | 0.8% | 0.8% |
| | Fenpropimorph | Fenpropimorph | Fenpropimorph |
| | | | 0.8% Imazalil |
| Propiconazole | 1.6% | 0.8% | 0.8% |
| | Propiconazole | Propiconazole | Propiconazole |
| | | | 0.8% Imazalil |
| Cyproconazole | 1.6% | 0.8% | 0.8% |
| | Cyproconazole | Cyproconazole | Cyproconazole |
| | | | 0.8% Imazalil |
| Imazalil | 1.6% | 0.8% | Not applicable |
| | Imazalil | Imazalil | |

Calculated half lives derived from the soil contact veneer tests are summarized below in Table 20:

TABLE 20
Solutions in IMS (Alcohol)

| | High level | Low level | Low level with |
|---|---|---|---|
| Fungicide | (1.6%) | (0.8%) | 0.8% Imazalil |
| Fenpropimorph | 4.17 weeks | 3.67 weeks | 5.83 weeks |
| | | | (5.17 weeks) |
| Propiconazole | 5.50 weeks | 5.33 weeks | 6.17 weeks |
| | | | (5.84 weeks) |
| Cyproconazole | 4.67 weeks | 4.17 weeks | 6.17 weeks |
| | | | (5.42 weeks) |
| Imazalil | 6.17 weeks | 5.50 weeks | Not applicable |

values in parentheses are estimated expected values

### EXAMPLE 11

This example describes the relationship between the concentration of imazalil sulfate and veneer half life. For this experiment, imazalil sulfate was used in combination with Propiconazole, Tebuconazole and ortho phenylphenol (OPP). The levels of Propiconazole, Tebuconazole and OPP were kept constant while the level of imazalil sulfate was varied in the different fluids.

Veneers were dip treated, dried, exposed to compost and tested as described in Example 1. The calculated half lives based on the time point at which the veneers broke is presented in Table 21.

TABLE 21

| Fluid Ref. # | % Imazalil sulfate | Calculated Half |
|---|---|---|
| Fluid 1* | 0% Imazalil sulfate * | 5.50 weeks |
| Fluid 2* | 0.2% Imazalil sulfate * | 5.50 weeks |
| Fluid 3* | 0.4% Imazalil sulfate * | 7.00 weeks |
| Fluid 4* | 0.8% Imazalil sulfate * | 8.00 weeks |
| Fluid 5* | 1.4% Imazalil sulfate * | 10.50 weeks |
| Fluid 6* | 2.0% Imazalil sulfate * | 10.83 weeks |
| Fluid 7 | 2.0% Imazalil sulfate * | 10.67 weeks |
| Water | — | 4.33 weeks |

* indicates the presence of 0.019% Propiconzole + 0.019% Tebuconazole + 0.1805% OPP.

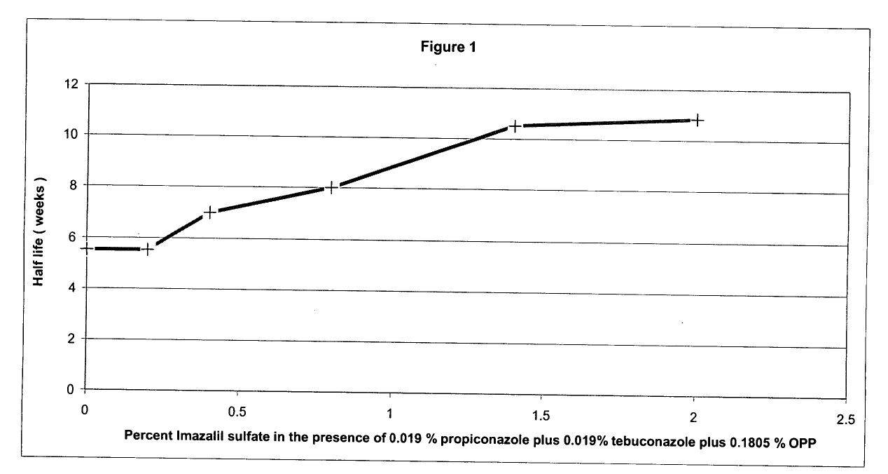

These data indicate that with increasing concentration of Imazalil sulfate, a corresponding increase in the half life is observed at least up to about 2% Imazalil sulfate (FIG. 1).

While specific examples have been presented to illustrate the invention, those skilled in the art will recognize that routine modifications can be made to the compositions and methods described herein which are intended to be within the scope of the present invention.

### EXAMPLE 12

This example describes the relationship between the concentration of imazalil sulfate and veneer half life. For this experiment, imazalil sulfate was used dissolved in deionized water.

Veneers were dip treated, dried, exposed to compost and tested as described in Example 1. The calculated half lives based on the time point at which the veneers broke is presented in Table 22.

TABLE 22

| Fluid Ref. # | % Imazalil sulfate | Calculated Half |
|---|---|---|
| Fluid 1 | 0.25% Imazalil sulfate | 5.00 weeks |
| Fluid 2 | 0.50% Imazalil sulfate | 6.50 weeks |
| Fluid 3 | 1.00% Imazalil sulfate | 6.83 weeks |
| Fluid 4 | 1.50% Imazalil sulfate | 8.17 weeks |
| Water | — | 4.00 weeks |

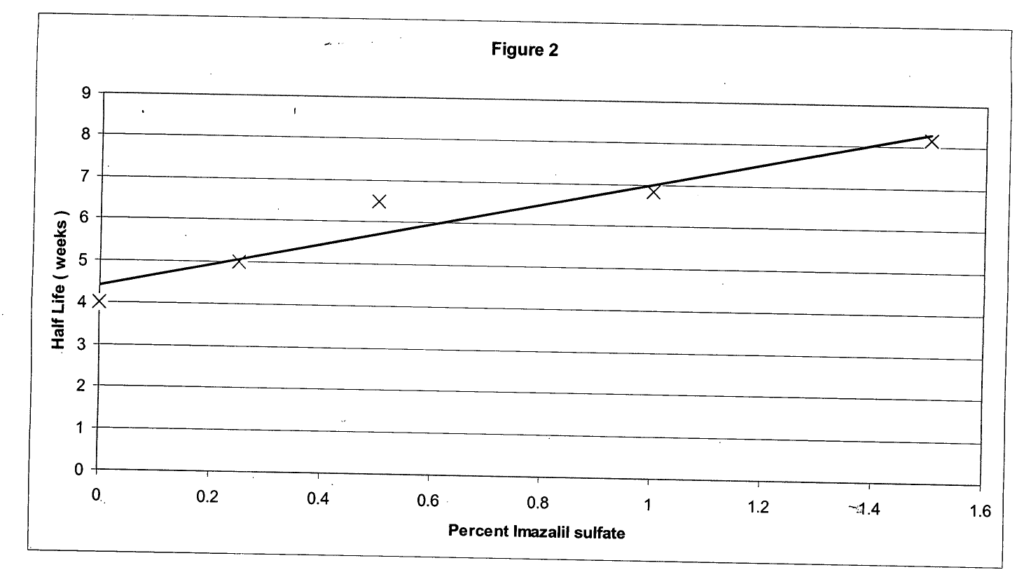

These data indicate that with increasing concentration of Imazalil sulfate, a corresponding increase in the half life is observed at least up to about 1.50% Imazalil sulfate (FIG. 2).

### EXAMPLE 13

This example describes the relationship between the concentration of imazalil and veneer half life. For this experiment imazalil was used dissolved in IMS (alcohol).

Veneers were dip treated, dried, exposed to compost and tested as described in Example 1. The calculated half lives based on the time point at which the veneers broke is presented in Table 22.

TABLE 22

| Fluid Ref. # | % Imazalil | Calculated Half |
|---|---|---|
| Fluid 1 | 0.25% Imazalil | 4.67 weeks |
| Fluid 2 | 0.50% Imazalil | 5.33 weeks |
| Fluid 3 | 1.00% Imazalil | 7.33 weeks |
| Fluid 4 | 1.50% Imazalil | 8.17 weeks |
| IMS (alcohol) | — | 4.00 weeks |

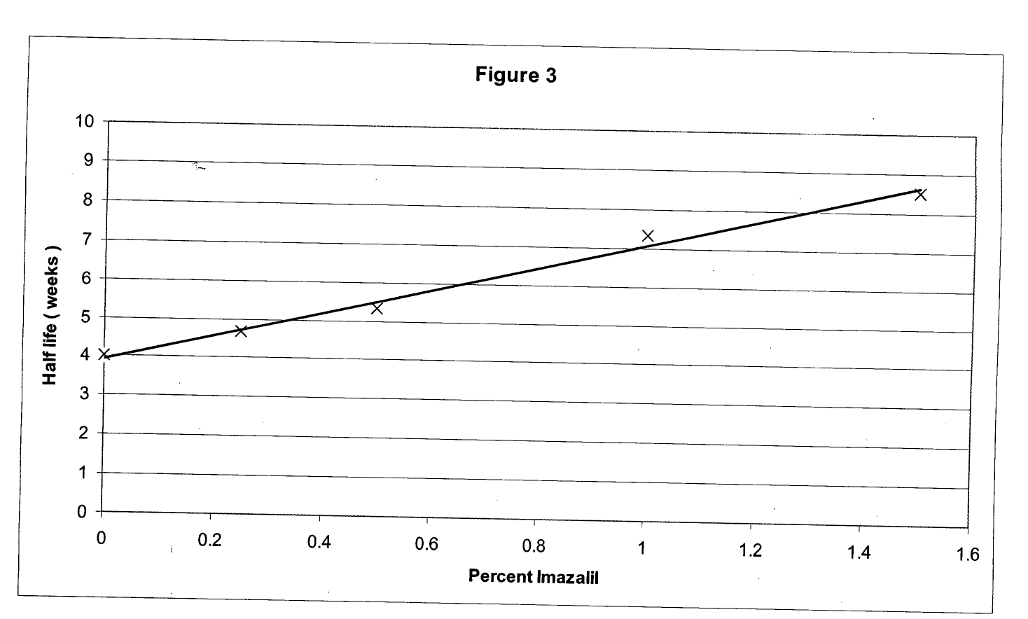

These data indicate that with increasing concentration of Imazalil, a corresponding increase in the half life is observed at least up to about 1.5% Imazalil (FIG. 3).

While specific examples have been presented to illustrate the invention, those skilled in the art will recognize that routine modifications can be made to the compositions and methods described herein which are intended to be within the scope of the present invention.

While specific examples have been presented to illustrate the invention, those skilled in the art will recognize that routine modifications can be made to the compositions and methods described herein which are intended to be within the scope of the present invention.

### EXAMPLE 14

This example demonstrates the synergy obtained when dichlorophen and imazalil sulfate are used together. The exposure test was performed and the half-lives calculated as in example 1. The combinations tested are illustrated in the table below:

TABLE 1A
Fungicide content of the formulations examined.

| Fungicide | No addition | With Imazalil sulfate |
|---|---|---|
| Dichlorophen | 0.6% Dichlorophen | 0.3% Dichlorophen plus |
| | | 0.2% Imazalil sulfate |
| Imazalil sulfate | 0.4% Imazalil sulfate | Not applicable |

Calculated half lives derived from the soil contact veneer test is summarized below in table 2A

TABLE 2A

| Fungicide | No addition | With Imazalil sulfate |
|---|---|---|
| Dichlorophen | 9.5 weeks | 11.2 weeks |
| | | {7.4 weeks} |
| Imazalil sulfate | 5.2 weeks | Not applicable |

The value in parentheses is the expected value
The half-life found for the dichlorophen plus imazalil sulfate combination exceeded the expected value.

### EXAMPLE 15

This example demonstrates the synergy obtained when dichlorophen and imazalil sulfate are used together. The exposure test was performed and the half-lives calculated as in example 1. The combinations tested are illustrated in the table below:

TABLE 1B
Solutions in IMS (Alcohol)

| Fungicide | No addition | With Imazalil sulfate |
|---|---|---|
| Dichlorophen | 2.0% Dichlorophen | 1.0% Dichlorophen plus |
| | | 1.0% Imazalil sulfate |
| Imazalil sulfate | 2.0% Imazalil sulfate | Not applicable |

Calculated half lives derived from the soil contact veneer tests are summarised below in Table 2B

TABLE 2B

| Fungicide | No addition | With Imazalil sulfate |
|---|---|---|
| Dichlorophen | 17.00 weeks | 19.67 weeks |
| | | {12.42 weeks} |
| Imazalil sulfate | 7.83 weeks | Not applicable |

The value in parentheses is the expected value
The half-life found for the dichlorophen plus imazalil sulfate combination exceeded the expected value.

### EXAMPLE 16

This example demonstrates the synergy obtained when dichlorophen and imazalil sulfate are used together. The exposure test was performed and the half-lives calculated as in example 1. The combinations tested are illustrated in the table below:

TABLE 1C
Solutions in IMS (Alcohol)

| | | | Low level with |
|---|---|---|---|
| Fungicide | High level | Low level | 0.8% Ima [symbol] sulfate |
| Dichlorophen | 1.6% | 0.8% | 0.8% Dichlorophen |
| | Dichlorophen | Dichlorophen | plus Imazalil sulfate |
| Imazalil | 1.6% Imazalil | 0.8% Imazalil | Not applicable |
| sulfate | sulfate | sulfate | |

Calculated half lives derived from the soil contact veneer tests are summarised below in Table 2C

TABLE 2C

| Dichlorophen | Imazalil sulfate | Calculated half life |
|---|---|---|
| 1.6% | — | 14.50 weeks |
| 0.8% | — | 11.33 weeks |
| — | 1.6% | 8.00 weeks |
| — | 0.8% | 7.00 weeks |
| 0.8% | 0.8% | 13.00 weeks |
| | | {11.25 weeks} |

The value in parentheses is the expected value

The half-life found for the dichlorophen plus imazalil sulfate combination exceeded the expected value.

Solutions in (IMS)

| | High level | Low level | Low level with 0.8% |
|---|---|---|---|
| Fungicide | (1.6%) | (0.8%) | Imazalil sulfate |
| Fenarimol | 1.6% Fenarimol | 0.8% Fenarimol | 0.8% Fenarimol plus |
| | | | 0.8% Imazalil sulfate |
| DDAC | 1.6% DDAC | 0.8% DDAC | 0.8% DDAC plus |
| | | | 0.8% Imazalil sulfate |
| Bardap 26 | 1.6% Bardap 26 | 0.8% Bardap 26 | 0.8% Bardap 26 plus |
| | | | 0.8% Imazalil sulfate |
| Imazalil | 1.6% Imazalil | 0.8% Imazalil | Not applicable |
| sulfate | sulfate | sulfate | |

Results

Solutions in (IMS)

| | | | Low level with |
|---|---|---|---|
| | High level | Low level | 0.8% Imazalil |
| Fungicide | (1.6%) | (0.8%) | sulfate |
| Fenarimol | 5.00 weeks | 4.50 weeks | 6.67 weeks |
| | | | {5.42 weeks} |
| DDAC | 5.33 weeks | 5.00 weeks | 5.50 weeks |
| | | | {5.58 weeks} |
| Bardap 26 | 5.17 weeks | 4.67 weeks | 4.83 weeks |
| | | | {5.50 weeks} |
| Imazalil | 5.83 weeks | 5.00 weeks | Not applicable |
| sulfate | | | |
| CarboQuat | 1.6% | 0.8% | 0.8% CarboQuat plus |
| | CarboQuat | CarboQuat | 0.8% Imazalil sulfate |
| PHMB | 1.6% PHMB | 0.8% PHMB | 0.8% PHMB plus |
| | | | 0.8% Imazalil sulfate |
| Salicylanilide | 1.6% | 0.8% | 0.8% Salicylanilide |
| | Salicylanilide | Salicylanilide | plus |
| | | | 0.8% Imazalil sulfate |
| Boric acid | 1.6% | 0.8% | 0.8% Boric acid plus |
| | Boric acid | Boric acid | 0.8% Imazalil sulfate |
| BAC | 1.6% BAC | 0.8% BAC | 0.8% BAC plus |
| | | | 0.8% Imazalil sulfate |
| Imazalil | 1.6% Imazalil | 0.8% I imazalil | Not applicable |
| sulfate | sulfate | sulfate | |

Results

Solutions in (IMS)

| | | | Low level with |
|---|---|---|---|
| | High level | Low level | 0.8% Imazalil |
| Fungicide | (1.6%) | (0.8%) | sulfate |
| Salicylanilide | 5.67 weeks | 4.83 weeks | 6.50 weeks |
| | | | {6.34 weeks} |
| Boric acid | 4.50 weeks | 3.83 weeks | 5.33 weeks |
| | | | {5.57 weeks} |
| BAC | 4.83 weeks | 4.67 weeks | 6.00 weeks |
| | | | {592 weeks} |
| Imazalil | 7.00 weeks | 5.67 weeks | Not applicable |
| sulfate | | | |

We claim:

1. A composition comprising:
a) Imazalil;
b) a co-biocide; and
c) a solvent;
wherein the Imazalil and the co-biocide are present in a weight ratio in the range of from 0.5 to 1.5 grams of Imazalil/Imazalil salt per gram of co-biocide, excluding the weight of Imazalil salt anions.

2. The composition of claim 1 wherein the Imazalil comprises between 0.1 and 1.5 wt % of the composition.

3. The composition of claim 1 wherein the co-biocide is selected from the group consisting of quaternary ammonium compounds, azoles, morpholines, fenarimol, PHMB, guazatine acetate, triameen, and pyraclostrobin.

4. The composition of claim 2 wherein the co-biocide is selected from the group consisting of DDAC, CarboQuat, BAC, BBIT, cyproconazole, propiconazole, tridemorph, fenpropimorph, RH-287, salicylanilide, triclosan and chlorothalonil.

5. The composition of claim 1 wherein the solvent is water, an aliphatic or aromatic hydrocarbon, an oxygenated solvent, or a processed or natural vegetable oil.

6. The composition of claim 5 wherein the solvent is selected from the group consisting of white spirit, odorless kerosene, diesel oil, xylene, toluene, an alcohol, a ketone, an ester, a glycol ether, linseed oil, castor oil and rape seed oil.

7. The composition of claim 1 wherein the Imazalil and/or Imazalil salt, the co-biocide or both are micronized.

8. A method for preserving wood comprising the step of applying a composition to wood, said composition comprising:
a) Imazalil; and
b) a co-biocide; and
c) a solvent;
such that the combination of the Imazalil and co-biocide is synergistic with respect to the half life of the wood.

9. A method as in claim 8 wherein the Imazalil and co-biocide in the composition applied to the wood are present in the composition a weight ratio in the range of from 0.5 to 1.5 grams of Imazalil per gram of co-biocide, excluding the weight of the anion of salts of Imazalil.

10. A method as in claim 8 wherein Imazalil, is present in the wood in a concentration of from 0.0001 to 0.2500 grams per gram of wood in the penetrated zone, excluding the weight of the anion of salts of Imazalil.

11. A method as in claim 8 wherein the co-biocide in the composition applied to the wood biocide is selected from the group consisting of quaternary ammonium compounds, azoles, morpholines, fenarimol, PHMB, guazatine acetate, triameen, and pyraclostrobin.

12. A method as in claim 8 wherein the co-biocide in the composition applied to the wood is selected from the group consisting of DDAC, -CarboQuat, BAC, BBIT, salicylanilide, cyproconazole, propiconazole, tridemorph, fenpropimorph, RH-287, triclosan and chlorothalonil.

13. A method as in claim 8 wherein the solvent in the composition applied to the wood is selected from the group consisting of water, an aliphatic or aromatic hydrocarbon, an oxygenated solvent, or a processed or natural vegetable oil.

14. A method as in claim 8 wherein the solvent in the composition applied to the wood is selected from the group consisting of white spirit, odorless kerosene, diesel oil, xylene, toluene, an alcohol, a ketone, an ester, a glycol ether, linseed oil, castor oil and rape seed oil.

15. A method as in claim 8 wherein the wherein Imazalil and/or Imazalil salt, the co-biocide, or both in the composition applied to the wood are micronized.

16. A method as in claim 15 wherein the composition is applied by impregnation.

17. Wood which has been treated with a composition comprising:
a) Imazalil; and
b) a co-biocide;
wherein a) and b) are present in a weight ratio in the range of from 0.5 to 1.5 grams of a) per gram of b).

18. The wood of claim 17 wherein the composition comprises a co-biocide which is selected from the group consisting of quaternary ammonium compounds, azoles, morpholines, fenarimol, PHMB, guazatine acetate, triameen, and pyraclostrobin.

19. The wood of claim 18 wherein the composition comprises a co-biocide is selected from the group consisting of DDAC, -CarboQuat, BAC, BBIT, salicylanilide, cyproconazole, propiconazole, tridemorph, fenpropimorph, RH-287, triclosan and chlorothalonil.

20. The wood of claim 17 wherein Imazalil is present in the wood in a concentration of from 0.0001 to 0.2500 grams per gram of wood in the penetrated zone, excluding the weight of the anion of Imazalil salt.
